(19) United States
(12) Patent Application Publication
(10) Pub. No.: US 2007/0146478 A1
(43) Pub. Date: Jun. 28, 2007

(54) Stereoscopic 3D rig calibration and viewing device

(76) Inventors: Bernard J. Butler-Smith, Malibu Lake, CA (US); Steven J. Schklair, Altadena, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/486,366

(22) Filed: Jul. 14, 2006

Related U.S. Application Data
(60) Provisional application No. 60/698,965, filed on Jul. 14, 2005.

(51) Int. Cl. H04N 13/02

(52) U.S. Cl. 348/47

(57) ABSTRACT

This invention uses image processing to process imagery from two cameras to display onto a single monitor in a multiple of modes. These image-processing functions are detailed here, as well as other processes to combine multiple functions in a single self-contained unit called the 3DRCV (3D Rig Calibrator and Viewer). The 3DRCV unit has been designed as a visual aid for the calibration 3D Camera platforms and rigs, and as a tool to verify acceptable settings during a 3D shoot.

### CROSS-REFERENCE TO RELATED APPLICATIONS

This application claims priority to provisional application entitled, 3D RIG CALIBRATION AND STEREOSCOPIC VIEWING DEVICE, filed Jul. 14, 2005, having a Ser. No. 60/698,965, which is hereby incorporated by reference in its entirety.

### FIELD OF THE INVENTION

The present invention relates generally to stereoscopic 3D camera and viewing systems.

### BACKGROUND OF THE INVENTION

It is critical for the creation of good 3D stereoscopic imagery, for the 3D camera rig to be mechanically as well as optically aligned. The aligned rig becomes the reference point from which the motion control electronics makes its calculations for accurate movement for the desired stereographic image capture.

This invention describes a process of using image-processing to provide a visual aid in this alignment, or calibration of the 3D camera rig.

A tri-level-sync generator is also included for gen-locking the cameras if required, as well as a wired and wireless 3D shutter-glasses interface.

### SUMMARY OF THE INVENTION

This invention contains, but is not limited to, the following functions:

1) The invention generates “Tri-Level Sync” outputs to gen-lock two HDTV cameras together

2) The invention generates “Bi-Level Sync” outputs to gen-lock two SDTV (NTSC/PAUSECAM) cameras together

3) The invention generates HDTV or SDTV video output to be viewed on an HDTV or SDTV monitor.

4) The invention generates a graticule center-cross overlaid over the output image which may be used for alignment

5) The invention has button or knob controls to control the unit

6) The invention has status LED or LCD indications of the status of the unit

7) The invention has a wired LCD shutter glasses interface

8) The invention has a wireless LCD shutter glasses interface

9) The invention has optional horizontal image-flipping (mirror) for use with a beam-splitter type 3D rig.

### BRIEF DESCRIPTION OF THE DRAWINGS

FIG. 1 shows a wiring diagram of a typical system, containing a stereoscopic 3D camera rig, the 3DRCV unit described in this invention, a monitor, and connections to power and 3D shutter-glasses.

FIG. 2 shows a block diagram of the internal functions of the 3DRCV

### DETAILED DESCRIPTION

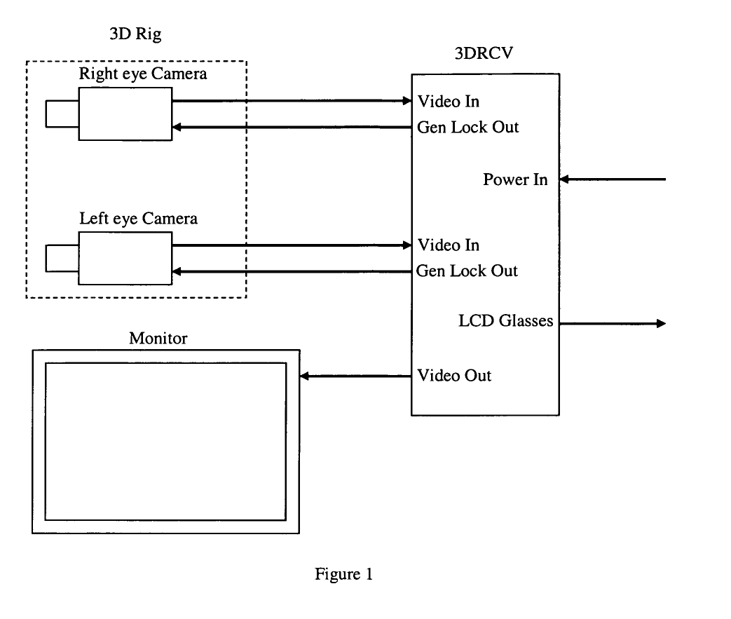

One embodiment of this invention (FIG. 1) comprises a unit which performs the image processing functions, described in the modes below, has a sync generation unit, has a 3D shutter glasses interface, and a button and status indicator user interface.

The unit connects to the 3D rig's cameras, and a monitor as shown in FIG. 1. The sync generation function feeds both cameras to gen-lock them together, which also gen-locks the output video signal to be displayed.

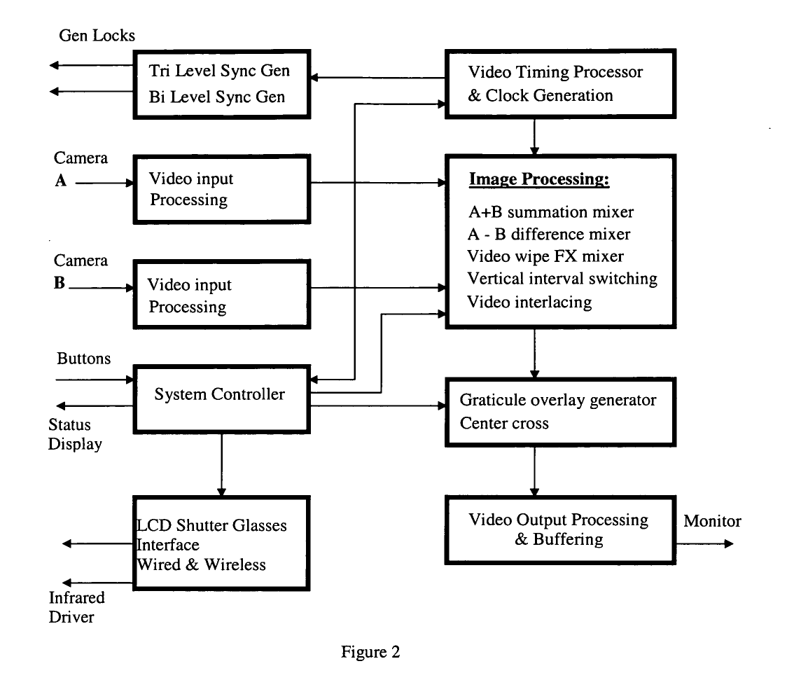

The 3DRCV consists of the function blocks shown in FIG. 2.

The video timing processor and clock generation unit generates all timing for image processing, and sync generation functions, which may consist of a precise clock oscillator, clock distribution and frequency division through discreet logic circuitry, and/or microcontrollers.

The sync generation unit, which has a programmable frame or field rate, is clocked from the video timing processor, and outputs bi-level or tri-level sync signals, which conforms to industry standard formats, levels and interface.

The video input processing units conform int inputs to levels required by the image-processing unit, and may optionally flip the source images horizontally and/or vertically to compensate for the camera in the 3D rig acquiring the image from a reflected surface, such as a beamsplitter mirror.

The system controller is responsible for “housekeeping” functions of the unit, for scanning buttons, displaying status information, and communicating formats to the image-processing unit.

The LCD shutter glasses interface unit generates signals for typical wired or wireless 3D shutter glasses. It provides voltages levels using voltage-level-translators derived from logic levels, and provides the pulses needed for infrared LEDs to conform to typical wireless shutter glasses.

The image processing unit performs analog and/or digital functions to the left-eye and right-eye source imagery, as described below, and provides a processed output imagery.

The graticule overlay generator inserts onto the output image from the image processor, lines which are overlaid as a graticule, consisting of center-cross-hairs, safe areas, or aspect-ratios. The lines may be white or black.

The video output buffering unit conforms the output image to industry standard levels, termination and interfacing, which may be digital or analog, such as SDTV, HDTV, NTSC, PAL, SECAM, VGA, DVI, ROB, RGBHV, YPbPr, etc.

The 3DRCV unit has been designed to support both Beamsplitter and Side-by-Side types of 3D cameras and rigs, using the latest HD or SD Video Cameras, but may also be used in conjunction with video taps in standard film type 3D camera rigs.

Modes of Operation:

The selectable Video Output Modes are:

1: Left Camera (Full Screen)

2: Right Camera (Full Screen)

3: Vertical Split (Screen Multiplex)

4: Horizontal Split (Screen Multiplex)

5: Left-Right Difference ((Camera A-Camera B) divided by 2)+50% gray, normalized.

6: Left+Right Summation Average (50% Camera A, 50% Camera B)

7: Field/Frame Interleave (Interlaced)

8: Left/Right Toggle (Vertical interval dwell switcher)

The detail of each of the 8 selectable output functions are described in detail below. They are accessed by the press of a button, and a status indicator provides visual status of the mode selected.

Mode 1: Left Camera

This switches the video output to the left camera, full screen. Use it when setting up the left camera on a waveform monitor to verify levels.

Mode 2: Right Camera

This switches the video output to the right camera, full screen. Use it when setting up the right camera on a waveform monitor to verify levels.

Mode 3: Vertical Split

This screen multiplexes the left camera on the left half of the screen, and the right camera on the right half of the screen. This will indicate the vertical disparity down the center of the screen. Use it to mechanically align the vertical offset of the cameras on the 3D rig so they match vertically. This is one of the most important 3D settings. On a beam-splitter 3D rig, null both cameras so they are superimposed. On a side-by-side 3D rig, converge to a target that aligns to the vertical center. Also used to view the vertical displacement during an end-to-end zoom, when used with a Siemens star. During a shoot, use this mode also to verify visually that the zooms match at all times.

Mode 4: Horizontal Split

This screen multiplexes the right camera on the top half of the screen, and the left camera on the bottom half of the screen. This will indicate the horizontal disparity across the center of the screen. Use it to align the horizontal offset of the cameras on the 3D rig so they match horizontally. On a beam-splitter 3D rig, null both cameras so they are superimposed. On a side-by-side 3D rig, converge to a target that aligns to the horizontal center, if possible. Also used to view the horizontal displacement during an end-to-end zoom, when used with a Siemens star.

Mode 5: Left-Right Difference

This mathematically cancels out parts of the image from both cameras which are equal. Therefore this mode can be used not only to match the imagery on both lenses and camera settings (e.g. Iris, Focus, Gain, Knee, Gamma), but mechanical alignments of the 3D rig. On a beam-splitter 3D rig, null both cameras so they are superimposed. Look at the screen in this mode, which should be ideally gray throughout the image, indicating perfect alignment. On a side-by-side 3D Rig where superimposition is not possible, ensure the gray runs down the vertical center of the screen. Perfect alignment is not usually possible, so consider a sweet-spot, where both cameras are aligned. If the display format is IMAX, the sweet-spot is ⅓ up the screen.

Mode 6: Left-Right Average

This averages the images from both cameras, which are superimposed such that when both cameras are perfectly aligned, they produce an undistorted output image. When there is horizontal or vertical displacement between the cameras, a “ghosting”, or double subject will appear in the direction of the displacement. Use this mode to verify mechanical alignment of the rig, when the cameras are nulled.

Mode 7: Field/Frame Interleave

This provides a field or frame interleaved video on the output, to be viewed as 3D using liquid crystal shutter (LCS) glasses, either wired or wireless.

When the video mode is interlaced, fields will be interleaved, and when the video mode is progressive, frames will be interleaved, always providing the fastest LCS shutter frequency:

1920×1080 30i (60 interlaced fields per second) provides a 30 Hz shutter ( 1/60s per eye)

1280×720 60p (60 progressive frames per second) provides a 30 Hz shutter ( 1/60s per eye)

720×480 60p (60 progressive frames per second) provides a 30 Hz shutter ( 1/60s per eye)

720×480 30i, NTSC (60 interlaced fields per second) provides a 30 Hz shutter ( 1/60s per eye)

Connect wired LCS glasses with the standard 3.5 mm plug used for most 3D glasses to the jack on the front of the 3DRCV, or if using wireless LCS glasses, ensure the front panel of the 3DRCV is in line of sight to the wireless glasses for proper operation. Both wired and wireless may be used simultaneously.

Mode 8: Left/Right Toggle

This toggles back and forth between the left camera and the right camera, every half-second.

This will provide a visual indication of any disparities between left and right cameras. Observe the focus, iris, zoom, and vertical disparity differences between both cameras. Also look for things such as lens-flare, which may appear on one camera and not the other.

What is claimed is:

1. A process of generating and outputting a single image, derived from two cameras of a 3D stereoscopic camera rig, using image-processing.

2. A process of applying claim 1, for use as a device to calibrate the mechanical properties of a stereoscopic 3D camera rig.

3. A process of applying claim 1, for use as a device to calibrate the optical properties of a stereoscopic 3D camera rig.

4. A process of applying claim 1, for use as a visual aid in shooting 3D imagery.

5. A method of claim 1, where the output image is a HDTV signal to be viewed on an HDTV monitor.

6. A method of claim 1, where the output image is a NTSC signal to be viewed on an NTSC monitor.

7. A method of claim 1, where the output image is a PAL signal to be viewed on an PAL monitor.

8. A method of claim 1, where the output image is a SECAM signal to be viewed on an SECAM monitor.

9. A method of claim 1, where the output image is a VGA-type format signal to be viewed on an computer-type monitor.

10. A method of claim 1, where the output image is a DVI-type format signal to be viewed on an computer-type monitor.

11. A method of claim 1, where the input images are gen-locked using an internal tri-level-sync generator.

12. A method of claim 1, where the input images are gen-locked using a bi-level-sync generator.

13. A method of claim 1, where the input images are time multiplexed between left-eye and right-eye imagery, to a single output, either on field or frame boundaries.

14. A process of viewing the output generated in claim 13, using hard wired 3D shutter glasses.

15. A process of viewing the output generated in claim 13, using wireless 3D shutter glasses.

16. A method of claim 1, where the output image is selected as the left-eye camera view.

17. A method of claim 1, where the output image is selected as the right-eye camera view.

18. A method of claim 1, where the output image is selected as a screen multiplexed image comprising of a vertical spilt between left-eye and right-eye camera views.

19. A method of claim 1, where the output image is selected as a screen multiplexed image comprising of a horizontal spilt between left-eye and right-eye camera views.

20. A method of claim 1, where the output image is selected as a combined left-eye and right-eye camera view, using a subtractive process.

21. A method of claim 19, where the subtraction is left-eye from right-eye imagery.

22. A method of claim 19, where the subtraction is right-eye from left-eye imagery.

23. A method of claim 19, where the subtraction is an absolute subtraction between left-eye from right-eye imagery.

24. A method of claim 19, where the subtraction is normalized such that the result of the subtraction will provide a 50%, or middle-gray output.

25. A method of claim 1, where the output image is selected as a combined left-eye and right-eye camera view, using a additive process.

26. A method of claim 24, where the addition weighted with half the intensity from the right-eye imagery, and half the intensity from the left-eye imagery, such that the maximum result will be at 100% and never saturate.

27. A method of claim 1, where the output image is selected as a time multiplexed between left-eye and right-eye imagery, to a single output, either on field or frame boundaries.

28. A method of claim 1, where the output image is selected as a time multiplexed between left-eye and right-eye imagery, to a single output, at slower than the frame rate.

29. A method of claim 1, where the selected output function described in claim 16 through claim 27, is controlled by a push-button.

30. A method of claim 1, where the selected output function described in claim 16 through claim 27, is displayed as a status indication.

31. A method of claim 29, where the status indication is LED technology.

32. A method of claim 29, where the status indication is LCD, or other screen technology.

33. A method of claim 1, where the output image is overlaid with a graticule, consisting of center-cross-hairs, safe areas, or aspect-ratios.

34. A method of claim 1, where the source imagery from either/both the left-eye and right-eye inputs can be horizontally and/or vertically flipped, to take into account image reversals when a camera in a typical beamsplitter 3D stereoscopic camera rig, uses a reflected surface
